(19) United States
(12) Patent Application Publication
(10) Pub. No.: US 2009/0225405 A1
(43) Pub. Date: Sep. 10, 2009

(54) Wide-Angle Lens, Optical Device Using the Wide-Angle Lens, and Method for Fabricating the Wide-Angle Lens

(75) Inventor: Hisayoshi Fujimoto, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD, KYOTO-SHI (JP)

(21) Appl. No.: 12/223,498

(22) PCT Filed: Feb. 1, 2007
(86) PCT No.: PCT/JP2007/051664

§ 371 Date: Oct. 6, 2008

(30) Foreign Application Priority Data
Feb. 3, 2006 (JP) 2006-027448
Apr. 4, 2006 (JP) 2006-103303

(51) Int. Cl. G02B 13/14; G02B 13/18; G02B 13/00

(52) U.S. Cl. 359/356

(57) ABSTRACT

A wide-angle lens includes an object-side lens group 200, an image-forming side lens group 400, and at least one converging lens 300 arranged between the object-side lens group 200 and the image-forming side lens group 400. The object-side lens group 200 includes at least one concave lens 210 including a convex light incident surface 211 on the object side. The light incident surface 211 of the concave lens 210 is a convex aspheric surface 211a whose curvature increases from a portion adjacent to the central optical axis toward the periphery of the lens. The concave lens further includes a light emitting surface 212 which is a substantially concave spherical surface.

### TECHNICAL FIELD

The present invention relates to a wide-angle lens, an optical device using a wide-angle lens, and a method for manufacturing a wide-angle lens.

### BACKGROUND ART

A lens whose angle of view is not smaller than 60° is called a wide-angle lens, and a lens whose angle of view is not smaller than 100° is called a super-wide-angle lens. An example of super-wide-angle lens is disclosed in Patent Document 1.

The super-wide-angle lens disclosed in Patent Document 1 includes a concave lens unit arranged on an object side and a converging lens unit arranged on an image-forming side. The concave lens unit comprises a concave lens group made up of a plurality of concave lenses. Generally, the angle of view of the wide-angle lens increases as the number of the concave lenses constituting the concave lens group increases. Further, to achieve a wide angle of view, as the concave lenses for constituting the concave lens group, use is made of a lens having a light incident surface comprising a convex surface and a light emitting surface comprising a concave surface. The light diverged by the concave lens unit and traveling toward an image-forming surface is converged by the converging lens unit to form an image on the image-forming surface.
Patent Document 1: JP-A-2005-345577

As to a wide-angle lens or a super-wide-angle lens having the above-described structure, efforts have been made to increase the angle of view and eliminate chromatic aberration. However, sufficient efforts have not been made to eliminate image distortion. As a wide-angle lens is commonly called a fish-eye lens, the image obtained by a wide-angle lens is considerably distorted particularly at the periphery. For instance, when an image of a rectangular object is captured by a conventional wide-angle lens in such a manner as to fill the screen, the image obtained is generally distorted largely into the form of a barrel. In this case, the distortion at the periphery of the image can reach 20% or more.

A wide-angle lens having the above-described structure is often used for a back monitor camera to be mounted on a vehicle or a security camera. However, due to the large image distortion caused by the wide angle of view, it is difficult to grasp the actual situation from the captured image.

If the image distortion of a wide-angle lens is considerably reduced, the application of a wide-angle lens greatly increases. For instance, by using a wide-angle lens, a thin image reader can be produced which is capable of instantaneously reading the two-dimensional image of a document placed on a document table without scanning, which can replace a scanner for reading a two-dimensional image by scanning a line sensor.

### DISCLOSURE OF THE INVENTION

It is, therefore, an object of the present invention to provide a wide-angle lens with reduced image distortion. Another object of the present invention to provide an optical device using such a wide-angle lens. Still another object of the present invention to provide a method for easily manufacturing such a wide-angle lens.

According to a first aspect of the present invention, there is provided a wide-angle lens comprising an object-side lens group, an image-forming side lens group, and at least one converging lens arranged between the object-side lens group and the image-forming side lens group. The object-side lens group comprises at least one concave lens including a convex light incident surface on the object side. The light incident surface of the concave lens is a convex aspheric surface whose curvature increases from a portion adjacent to a central optical axis toward a periphery of the lens. The concave lens further includes a light emitting surface which is a substantially concave spherical surface.

In a preferred embodiment, the image-forming side lens group is designed to be capable of forming an image of an object on an image-forming surface by itself with reduced image distortion.

In a preferred embodiment, the object-side lens group consists of the single concave lens, and the wide-angle lens has an angle of view in a range of 60° to 100° and image distortion of not more than ±3%.

In a preferred embodiment, the object-side lens group consists of the two concave lenses, and the wide-angle lens has an angle of view in a range of 100° to 130° and image distortion of not more than ±3%.

In a preferred embodiment, the object-side lens group consists of the three concave lenses, and the wide-angle lens has an angle of view in a range of 100° to 170° and image distortion of not more than +3%.

Preferably, when the object-side lens group consists of two or more concave lenses, the concave lens arranged closest to an object is made of resin, whereas the other concave lens or lenses are made of molded glass whose Abbe number is not smaller than 70.

In a preferred embodiment, the Abbe number of the converging lens is smaller than the Abbe number of the concave lens constituting the object-side lens group. Preferably, in this case, the concave lens constituting the object-side lens group and the converging lens are made of resin.

According to a second aspect of the present invention, there is provided an optical device comprising a wide-angle lens according to the first aspect of the present invention and a two-dimensional area sensor which is so arranged that its light receiving surface is located on the image-forming surface.

According to a third aspect of the present invention, there is provided a camera module comprising a wide-angle lens according to the first aspect of the present invention and a two-dimensional area sensor which is so arranged that its light receiving surface is located on the image-forming surface. The camera module is designed to obtain a two-dimensional image of an object by the two-dimensional area sensor.

According to a fourth aspect of the present invention, there is provided an image reader comprising a transparent document table and a camera module according to the third aspect of the present invention arranged below the document table. The image reader is designed to obtain a two-dimensional image of a document placed on the document table by the two-dimensional area sensor.

According to a fifth aspect of the present invention, there is provided a method for manufacturing a wide-angle lens comprising an object-side lens group, an image-forming side lens group, and at least one converging lens arranged between the object-side lens group and the image-forming side lens group. The object-side lens group comprises at least one concave lens including a convex light incident surface on the object side. The light incident surface of the concave lens comprises a convex aspheric surface. The concave lens further includes a light emitting surface which is a substantially concave spherical surface. The method comprises the steps of preparing the image-forming side lens group to be capable of forming an image of an object on an image-forming surface by itself with reduced image distortion, and determining specifications of the lens for constituting the object-side lens group and the converging lens so that an image with reduced image distortion is to be formed on the image-forming surface.

According to a sixth aspect of the present invention, there is provided a method for manufacturing a wide-angle lens comprising an object-side lens group; an image-forming side lens group, and at least one converging lens arranged between the object-side lens group and the image-forming side lens group. The object-side lens group comprises one or a plurality of concave lenses each including a light incident surface which is a convex aspheric surface and a light emitting surface which is a substantially concave spherical surface. The method is capable of producing wide-angle lenses of different angles of view by appropriately selecting the number of the concave lenses for constituting the object-side lens group. The method comprises preparing the image-forming side lens group by using a lens group of predetermined specifications which make it possible to form an image of an object on an image-forming surface by itself with reduced image distortion. In this method, when the object-side lens group is to consist of a single concave lens, specifications of the single concave lens and the converging lens are so determined that an image with reduced image distortion is to be formed on the image-forming surface. When the object-side lens group is to consist of two or more concave lenses, the specifications of the single concave lens for the structure in which the object-side lens group consists of a single concave lens is used as it is, and one or more additional concave lenses are arranged on the object side of the concave lens, and specifications of the additional concave lens or lenses and the converging lens are so determined that an image with reduced image distortion is to be formed on the image-forming surface.

### BRIEF DESCRIPTION OF THE DRAWINGS

FIG. 1 is a schematic structural view of a cameral module incorporating a wide-angle lens according to a first embodiment of the present invention.

FIG. 2 is a schematic structural view of a cameral module incorporating a wide-angle lens according to a second embodiment of the present invention.

FIG. 3 is a schematic structural view of a cameral module incorporating a wide-angle lens according to a third embodiment of the present invention.

FIG. 4 is a schematic structural view of a cameral module incorporating a wide-angle lens according to a fourth embodiment of the present invention.

FIG. 5 is a sectional view of an image reader structured using a wide-angle lens and a cameral module according to the present invention.

FIG. 6 is a sectional view taken along lines VI-VI in FIG. 5.

### BEST MODE FOR CARRYING OUT THE INVENTION

Preferred embodiments of the present invention will be described below with reference to the accompanying drawings.

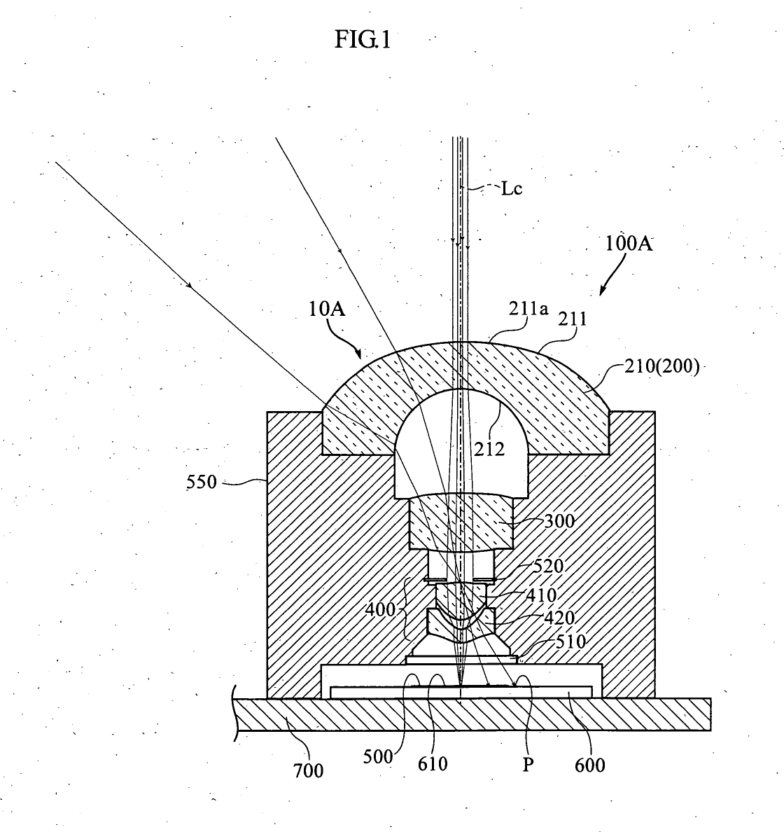

FIG. 1 shows the overall structure of a camera module 100A incorporating a wide-angle lens 10A according to a first embodiment of the present invention.

The wide-angle lens 10A includes an object-side lens 200 comprising a concave lens 210, an image-forming side lens group 400 comprising a plurality of lenses 410 and 420, and a converging lens 300 arranged between the object-side concave lens 210 and the image-forming side lens group 400. The lenses 210, 300, 410 and 420 are arranged along a common central axis Lc and held by a lens holder 550. A two-dimensional area sensor 600, which may be a CCD sensor, is so arranged that its light receiving surface 610 is located on an image-forming surface 500. The two-dimensional area sensor 600 is mounted on a substrate 700. The lens holder 550 is also mounted on the substrate 700 to define the positional relationship among the lenses 210, 300, 410, 420 and the positional relationship between each of the lenses 210, 300, 410, 420 and the image-forming surface 500. In the figure, the reference number 520 indicates a diaphragm for limiting the diameter of the light traveling toward image-forming side lens group 400 to a predetermined range, whereas the reference number 510 indicates an infrared light filter.

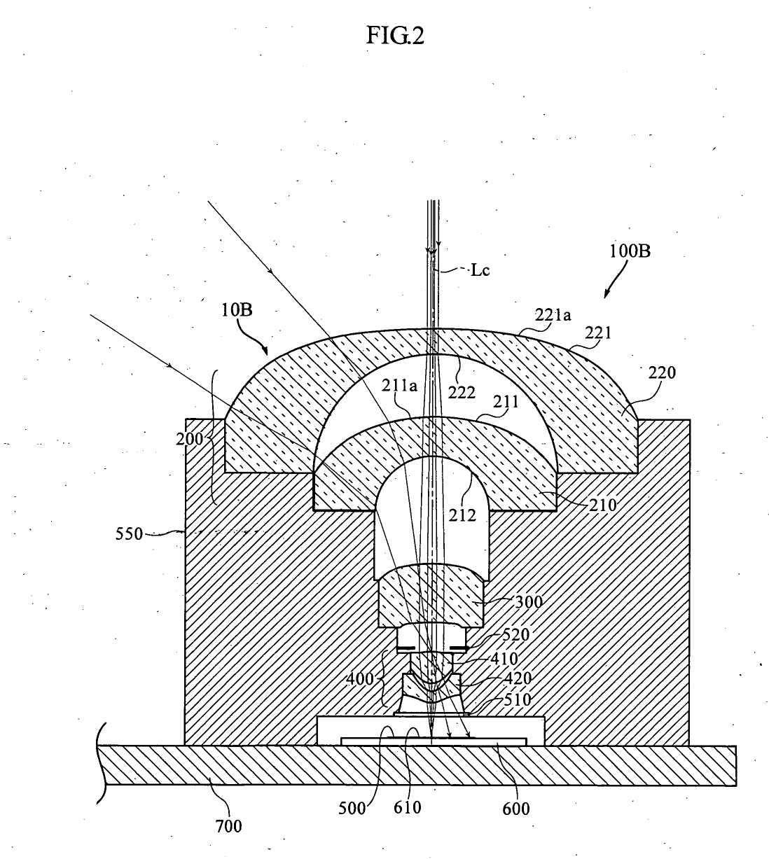

The object-side concave lens 210 includes a light incident surface 211 on the object side and a light emitting surface 212 on the image-forming side. The light incident surface 211 comprises a convex aspheric surface 211a, whereas the light emitting surface 212 includes a concave spherical surface region. In this embodiment, the central angle of the concave spherical surface region is approximately 180°. The convex aspheric surface 211a constituting the light incident surface 211 is configured to have a larger curvature at a portion farther from the central axis Lc of the lens. However, since the object-side lens 210 is a concave lens as a whole, at any point of the light incident surface 211, the curvature is smaller than that of the light-emitting surface 212. It is preferable that the light emitting surface 212 is an accurate concave spherical surface. However, the light emitting surface may be coated with resin for achromatizing or slightly varied for correcting various aberrations as long as the surface keeps a substantially concave spherical configuration. This holds true for other embodiments shown in FIG. 2 and the subsequent drawings.

In this embodiment, the image-forming side lens group 400 comprises the convex aspheric lens 410 and the concave aspheric lens 420. The image-forming side lens group 400 is designed to be capable of forming an image of an object on the image-forming surface by itself with reduced aberration. As shown in FIG. 1, the light rays entering the image-forming side lens group 400 to reach the image-forming surface 500 are parallel or generally parallel with each other, which indicates that the image-forming side lens group 400 is capable of forming an image of an object on the image-forming surface 500 by itself. That is, in the wide-angle lens 10A according to the present invention, a known lens group or a lens group designed to be usable by itself as a standard lens is used as the image-forming side lens group 400, and the object-side concave lens 210 and the converging lens 300 are added to the image-forming side lens group to increase the angle of view and reduce the image distortion.

Since the object-side lens 200 is a concave lens, the light rays diverge from the light emitting surface 212 of the object-side lens 200. The converging lens 300 changes the diverging light rays to parallel or generally parallel light rays to cause the light rays to impinge on the image-forming side lens group 400 (see FIG. 1). Thus, the converging lens 300 is a convex lens as a whole.

As noted before, the light incident surface 211 of the object-side concave lens 210 is configured to have a larger curvature at a portion farther from the central axis Lc of the lens. Thus, as compared with the structure in which the entire light incident surface is a convex spherical surface in which the curvature adjacent to the central axis is maintained throughout the surface, the structure of this embodiment ensures that an image of an object located close to the central axis Lc is formed at a peripheral point P of the image-forming surface 500. This indicates that the distortion of the image formed on the image-forming surface 500 reduces.

In this embodiment, the wide-angle lens 10A with reduced image distortion is provided by configuring the light incident surface 211 of the concave lens 210, which is closest to the object, as the convex aspheric surface 211a.

In the first embodiment shown in FIG. 1, by employing the single concave lens 210 as the object-side lens 200, the angle of view up to about 90° and image distortion of not more than ±3% are achieved.

To manufacture the wide-angle lens 10A, the specifications of each lens 210, 300, 410, 420 need to be determined. The profile of the aspheric surface is determined using a known formula. The structure of this embodiment includes four lenses. If the light incident surfaces and light emitting surfaces of all the four lenses are aspheric, a large amount of calculation needs to be performed to determine the eight aspheric profiles so as to make the image distortion be not more than a predetermined level, which is not practical.

However, in the wide-angle lens 10A according to this embodiment, the aspheric profile of each lens 410, 420 constituting the image-forming side lens group 400 is already determined. Further, as to the light emitting surface 212 of the object-side concave lens 210, it is not necessary to determine the aspheric profile, because it is a concave spherical surface. Thus, it is only necessary to determine the aspheric profile of the light incident surface 211 of the object-side concave lens 210 and additionally determine the aspheric profile of the converging lens 300, so that a large amount of calculation is not necessary.

FIG. 2 shows the overall structure of a camera module 100B incorporating a wide-angle lens 10B according to a second embodiment of the present invention.

The wide-angle lens 10B of the second embodiment differs from the wide-angle lens 10A of the first embodiment shown in FIG. 1 in that the wide-angle lens 10B includes two concave lenses 210 and 220 which constitute an object-side lens group 200. The wide-angle lens 10B of the second embodiment is the same as that of the first embodiment in that it includes an image-forming side lens group 400, a converging lens 300 is arranged between the object-side lens group 200 and the image-forming side lens group 400, the lenses 210, 220, 300, 410, 420 are supported by a lens holder 550 mounted on a substrate 700, a diaphragm 520 and an infrared light filter 510 are arranged at predetermined positions, and a light receiving surface 610 of a two-dimensional area sensor 600 mounted on the substrate 700 is arranged on an image-forming surface 500.

Of the two concave lenses 210 and 220 constituting the object-side lens group 200 in the wide-angle lens 10B, the lens 210 positioned on the image-forming side comprises a lens having the same specification as that of the concave lens 210 of the first embodiment shown in FIG. 1. Further, as the image-forming side lens group 400, a lens group having the same specification as that of the image-forming side lens group 400 of the first embodiment is employed. That is, the wide-angle lens 10B of the second embodiment is obtained by adding a second object-side concave lens 220 to the wide-angle lens 10A shown in FIG. 1 and replacing the converging lens 300 of the wide-angle lens 10A with a different one.

Due to addition of the concave lens 220 for constituting the object-side lens group 200, the degree of divergence of the light rays emitted from the object-side lens group 200 increases as compared with the first embodiment. This is the reason why the converging lens 300 is replaced. In this embodiment again, the converging lens 300 serves to change the diverging light rays to parallel or generally parallel light rays to cause the light rays to impinge on the image-forming side lens group 400.

The concave lens 220 added to the object side includes a light incident surface 221 comprising a convex aspheric surface 221a and a light emitting surface 222 comprising a concave spherical surface. In this embodiment again, the central angle of the concave spherical light-emitting surface 222 is approximately 180°. The convex aspheric surface 211a of the light incident surface 221 is configured to have a larger curvature at a portion farther from the central axis Lc of the lens. This arrangement reduces the image distortion, as noted before with respect to the object-side concave lens 210 of the wide-angle lens 10A shown in FIG. 1.

The structure of the second embodiment includes five lenses 210, 220, 300, 410 and 420. If the light incident surfaces and light emitting surfaces of all the five lenses are aspheric and the aspheric profiles of all these surfaces need to be determined so as to make the image distortion be not more than a predetermined level, a large amount of calculation needs to be performed, which is not practical. However, as noted before, the aspheric profile of each lens constituting the image-forming side lens group 400 is already determined. Further, of the two concave lenses 210 and 220 constituting the object-side lens group 200, the profile of the concave lens 210 on the image-forming side is already determined. Moreover, as to the light emitting surface 222 of the additional concave lens 220 constituting the object-side lens group 200, It is not necessary to determine the aspheric profile, because it is a concave spherical surface. Thus, to manufacture the wide-angle lens 10B of the second embodiment, it is only necessary to determine the aspheric profile of the light incident surface 221 of the additional concave lens 220, so that a large amount of calculation is not necessary.

In the second embodiment shown in FIG. 2, by employing two concave lenses 210 and 220 as the object-side lens group 200, the angle of view up to about 110° and image distortion of not more than +3% are achieved.

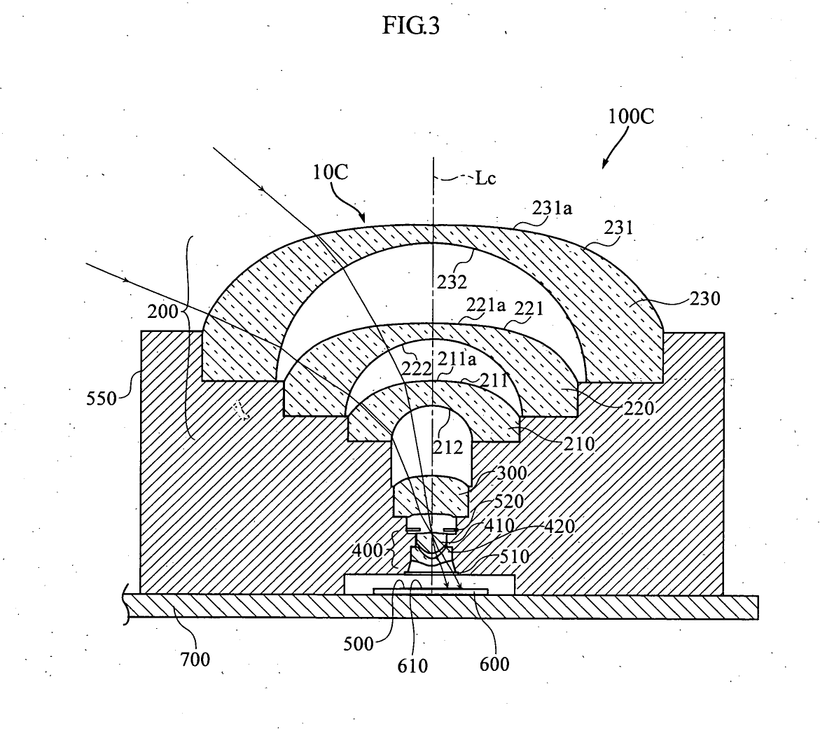

FIG. 3 shows the overall structure of a camera module 100C incorporating a wide-angle lens 10C according to a third embodiment of the present invention.

The wide-angle lens 10C of the second embodiment differs from the wide-angle lens 10A of the first embodiment shown in FIG. 1 in that the wide-angle lens 10C includes three concave lenses 210, 220 and 230 which constitute an object-side lens group 200. The wide-angle lens 10C of the third embodiment is the same as that of the first embodiment shown in FIG. 1 in that it includes an image-forming side lens group 400, a converging lens 300 is arranged between the object-side lens group 200 and the image-forming side lens group 400, the lenses 210, 220, 230, 300, 410, 420 are supported by a lens holder 550 mounted on a substrate 700, a diaphragm 520 and an infrared light filter 510 are arranged at predetermined positions, and a light receiving surface 610 of a two-dimensional area sensor 600 mounted on the substrate 700 is arranged on an image-forming surface 500.

Of the three concave lenses 210, 220 and 230 constituting the object-side lens group 200 in the wide-angle lens 10C, the two concave lenses 210 and 220 positioned on the image-forming side comprise lenses having the same specification as that of the two concave lenses 210 and 220 of the second embodiment shown in FIG. 2. Further, as the image-forming side lens group 400, a lens group having the same specification as that of the image-forming side lens group 400 of the first embodiment shown in is employed. That is, the wide-angle lens 10C of the third embodiment is obtained by adding a third object-side concave lens 230 to the wide-angle lens 10B shown in FIG. 2 and replacing the converging lens 300 of the wide-angle lens 10B with a different one.

Due to addition of the concave lens 230 for constituting the object-side lens group 200, the degree of divergence of the light rays emitted from the object-side lens group 200 increases as compared with the first and the second embodiments. This is the reason why the converging lens 300 is replaced. In this embodiment again, the converging lens 300 serves to change the diverging light rays to parallel or generally parallel light rays to cause the light rays to impinge on the image-forming side lens group 400.

The third concave lens 230 added to the object side includes a light incident surface 231 comprising a convex aspheric surface 231a and a light emitting surface 232 comprising a concave spherical surface. In this embodiment again, the central angle of the concave spherical light-emitting surface 232 is approximately 180°. The convex aspheric surface 231a of the light incident surface 231 is configured to have a larger curvature at a portion farther from the central axis Lc of the lens. This arrangement reduces the image distortion, as noted before with respect to the embodiments shown in FIGS. 1 and 2.

The structure of the third embodiment includes six lenses 210, 220, 230, 300, 410 and 420. If the light incident surfaces and light emitting surfaces of all the six lenses are aspheric and the aspheric profiles of all these surfaces need to be determined so as to make the image distortion be not more than a predetermined level, a large amount of calculation needs to be performed, which is not practical. However, as noted before, the aspheric profile of each lens constituting the image-forming side lens group 400 is already determined. Further, of the three concave lenses 210, 220 and 230 constituting the object-side lens group 200, the profile of the two concave lenses 210 and 220 on the image-forming side is already determined. Moreover, as to the light emitting surface 232 of the additional concave lens 230 constituting the object-side lens group 200, it is not necessary to determine the aspheric profile, because it is a concave spherical surface. Thus, to manufacture the wide-angle lens 10C of the third embodiment, it is only necessary to determine the aspheric profile of the light incident surface 231 of the additional concave lens 230, so that a large amount of calculation is not necessary.

In the third embodiment shown in FIG. 3, by employing three concave lenses 210, 220 and 230 as the object-side lens group 200, the angle of view up to about 160° and image distortion of not more than ±3% are achieved.

In this way, the above-described lenses 10A, 10B and 10C achieve a reduction in image distortion, although they are wide-angle lenses. As described before, each of the wide-angle lenses includes an object-side lens group 200 and an image-forming side lens group 400. The image-forming side lens group 400 is designed to be capable of forming an image of an object on the image-forming surface by itself. The light incident surfaces 211, 221, 231 of the concave lenses 210, 220, 230 constituting the object-side lens group 200 comprise convex aspheric surfaces 211a, 221a, 231a. With this arrangement, the calculation for determining the aspheric profile of the convex aspheric surfaces is performed easily using a formula so as to achieve a reduction in image distortion.

In the wide-angle lenses 10A, 10B and 10C, the light rays incident on the periphery of the lens need to be greatly refracted by each concave lens. Thus, it is preferable that the index of refraction of the material of the concave lenses 210, 220 and 230 is as high as possible. Further, in capturing a color image, as the angle of view increases, color blurring is more likely to occur at the periphery of an object image. Such color blurring occurs in such a manner that blue deviates inward while red deviates outward. To reduce such color blurring, it is preferable to make a lens using a material whose change in index of refraction depending on the light wavelength is as small as possible, i.e., a material having a large Abbe number.

Generally, glass-based materials have a larger Abbe number than that of resin-based materials. However, molding of a concave lens using such a glass-based material requires long time for heating and cooling. Thus, in terms of productivity, molding of a concave lens using glass-based materials is inferior to that using resin-based materials.

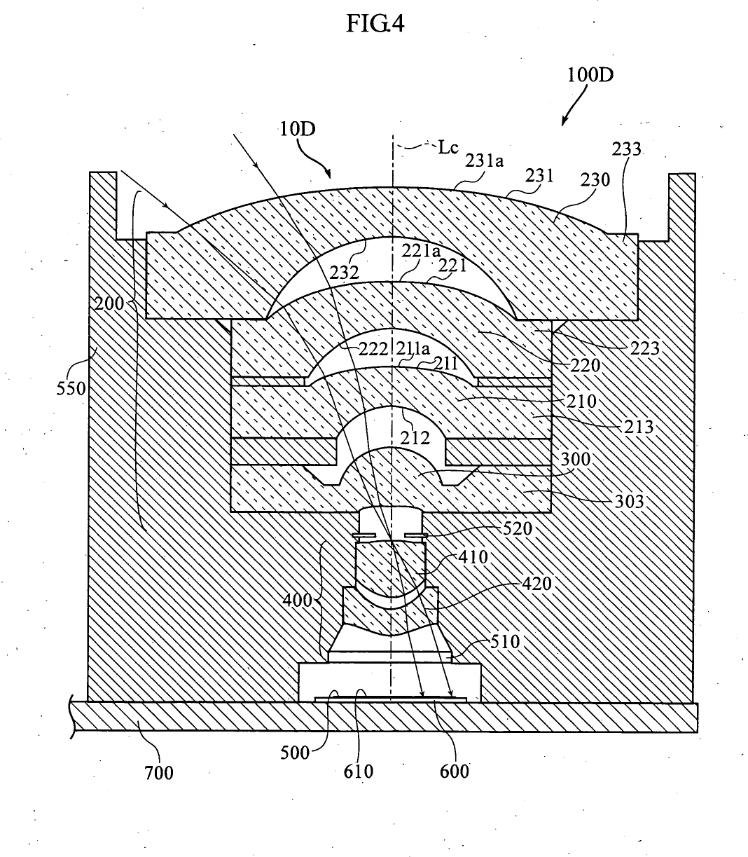

FIG. 4 shows a wide-angle lens 10D according to a fourth embodiment of the present invention, which is designed to achieve a high productivity and reduce the color blurring in the image.

The wide-angle lens 10D is the same as the wide-angle lens 10C of the third embodiment in arrangement of the lenses. The wide-angle lens 10D includes three concave lenses 210, 220 and 230 which constitute an object-side lens group 200. The wide-angle lens 10D further includes an image-forming side lens group 400, and a converging lens 300 arranged between the object-side lens group 200 and the image-forming side lens group 400. The lenses 210, 220, 230, 300, 410, 420 are supported by a lens-holder 550 mounted on a substrate 700. The three concave lenses 210, 220, 230 and the converging lens 300 include flange portions 213, 223, 233 and 303 for facilitating proper holding by the holder 550. A diaphragm 520 and an infrared light filter 510 are arranged at predetermined positions. A light receiving surface 610 of a two-dimensional area sensor 600 mounted on the substrate 700 is arranged on an image-forming surface 500. Similarly to the concave lenses of the foregoing embodiments, the light incident surfaces 211, 221 and 231 of the three concave lenses 210, 220 and 230 constituting the object-side lens group 200 comprise convex aspheric surfaces 211a, 221a and 231a designed to have a larger curvature at a portion farther from the central axis of the lens. The light emitting surfaces 212, 222 and 232 are substantially concave spherical surfaces. The image-forming side lens group 400 is designed to be capable of forming an image of an object on the image-forming surface by itself with reduced image distortion.

In this embodiment, the central angle of the concave spherical surface region of the light emitting surface 212, 222, 232 of each concave lens 210, 220, 230 is smaller than that of the foregoing embodiments. However, due to the use of three concave lenses, the angle of view of not smaller than 100° and image distortion of not more than ±3% are achieved.

To provide a wide angle of view, the lens diameter of the concave lens 230, which is closest to the object among the three concave lenses 210, 220 and 230 constituting the object-side lens group 200, is made larger than the lens diameter of other two concave lenses 210 and 220. As noted before, to reduce the color blurring of the captured image, it is desirable to make a concave lens by using a glass-based material whose Abbe number is large. However, when the lens diameter of the lens to be formed is relatively large, to form the lens by molding a glass-based material requires a long time for heating and cooling, which is not efficient. Thus, the lenses 210 and 220 having a relatively small lens diameter may be made of a glass-based material whose Abbe number is relatively large, whereas the lens 230 having a relatively large lens diameter may be made of a resin-based material. In this case, a high productivity is achieved.

As the glass-based material, use may be made of a material whose Abbe number is not smaller than 70. Specifically, for instance, use may be made of “PKF 80” (Abbe Number: 81.5, index of refraction: 1.497) available from SUMITA Optical Glass, Inc. or “FCD1” (Abbe Number: 81.6, index of refraction: 1.497) available from HOYA CORPORATION.

As to the resin-based material for molding the concave lens 230, it is preferable that the Abbe number is as large as possible. For instance, use may be made of “ZEONEX 480R” (Abbe Number: 56.2, index of refraction: 1.525) available from ZEON CORPORATION or “ARTON-F” (Abbe Number: 56.3, index of refraction: 1.513) available from JSR Corporation.

Alternatively, all the three concave lenses 210, 220 and 230 may be made of a resin-based material having a large Abbe number like the above-described “ZEONEX 480R” or “ARTON-F”. In this case, the productivity of the object-side lens group 200 is further enhanced.

In this way, by making the concave lenses 210, 220 and 230 of the object-side lens group 200 by using a material whose Abbe number is large, a lens is produced which reduces image distortion and color blurring in capturing a color image while achieving a large angle of view. With this arrangement, however, color blurring cannot be eliminated completely, because light rays are greatly refracted particularly at the periphery of the object-side lens group 200 before the light rays impinge on the converging lens 300.

To solve this problem, in the wide-angle lens 10D according to the fourth embodiment, the converging lens 300, which is a convex lens, is made of a material whose Abbe number is smaller than that of the concave lenses 210, 220 and 230. That is, as the material of the converging lens 300 which refracts light rays in the converging direction after the light rays are divergently refracted by the concave lenses 210, 220 and 230, a material whose Abbe number is relatively small is employed unlike the material of the concave lenses 210, 220 and 230. By this arrangement, the color blurring caused by the passing of light rays through the concave lenses 210, 220 and 230 is eliminated.

For instance, when the above-described “ZEONEX 480R” (Abbe Number: 56.2, index of refraction: 1.525) or “ARTON-F” (Abbe Number: 56.3, index of refraction: 1.513) is used as the material of the concave lenses 210, 220 and 230, polycarbonate whose Abbe number is relatively low (Abbe Number: 31.1, index of refraction: 1.585) may be used as the material of the converging lens 300.

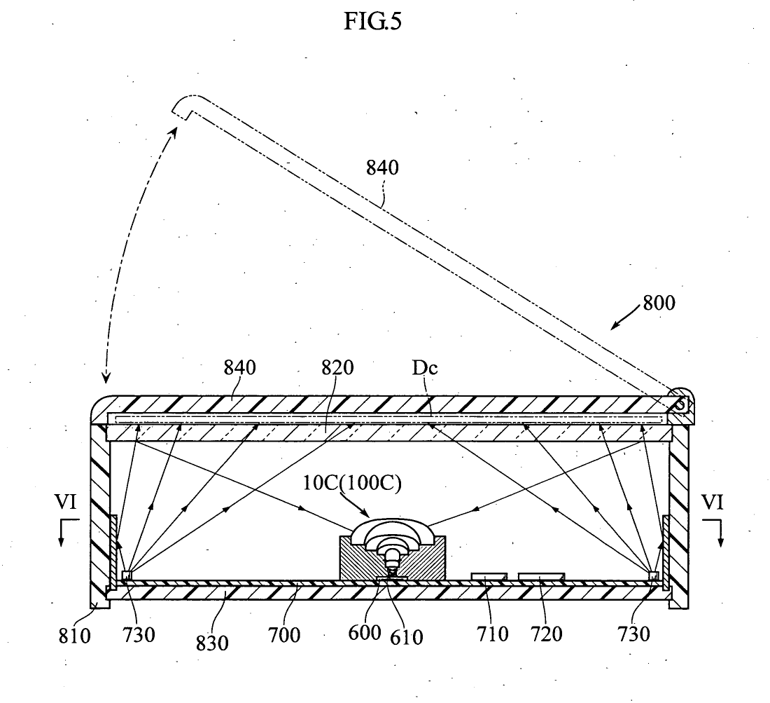

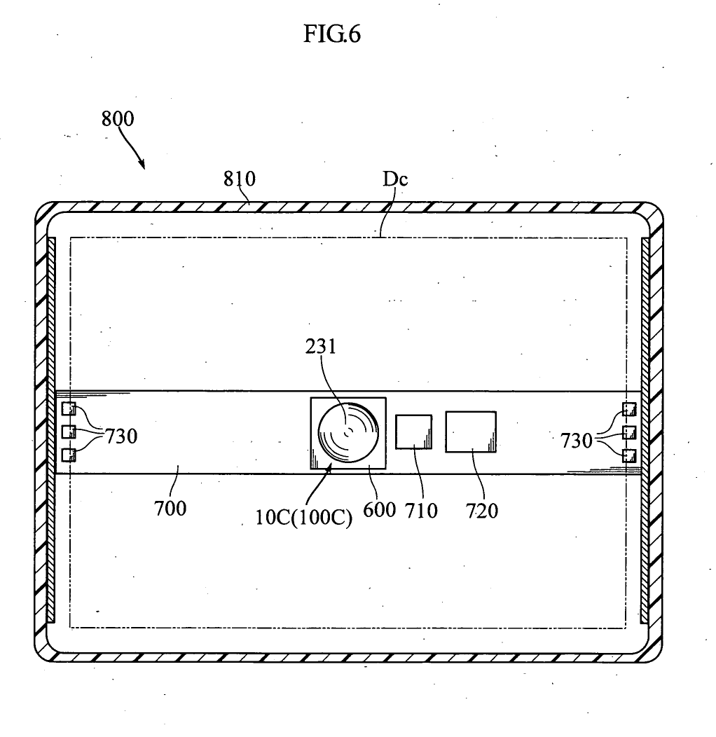

FIGS. 5 and 6 show a schematic structure of an image reader 800 which is an example of optical device incorporating the wide-angle lens 10C and the camera module 100C of the foregoing embodiment.

The image reader 800 includes a box-shaped case 810, a document table 820 made of e.g. transparent glass and arranged on top of the case 810, and the camera module 100C arranged on a bottom plate 830 of the case 810. As the camera module, the use of the camera module 100C shown in FIG. 3 which includes three concave lenses as the object-side lens group 200 is most desirable, because it provides the advantages such as the utilization of a wide angle of view of about 160° and a reduction in thickness of the case and hence a reduction in thickness of the image reader 800. However, the camera modules 100A, 100B and 100D shown in FIGS. 1, 2 and 4 may be employed.

A cover 840 for covering the document table 820 is supported at an end by an edge of the upper surface of the case 810 to be pivotable for opening and closing movement. An LED element 730 as the illumination light source and semiconductor devices 710 and 720 for obtaining an image from the two-dimensional area sensor 600, controlling light emission of the LED element 730, transferring image data and soon are mounted on an extended portion of the substrate 700 of the camera module 100C.

The image reader 800 is capable of instantaneously capturing a two-dimensional image of a document Dc placed on the document table 820 with reduced image distortion.

The present invention is not limited to the foregoing embodiments, and all the variations within the scope of the following claims are intended to be included in the scope of the present invention.

Although the number of the lenses constituting the object-side lens group 200 is three at the most in the foregoing embodiments, the object-side lens groups 200 may consist of four or more lenses.

Although a single convex lens is used as the converging lens 300 in the foregoing embodiments, a plurality of lenses may be used as the converging lenses when the number of lenses constituting the object-side lens group 200 is increased.

For instance, instead of an image reader as described above, the optical device incorporating a camera module according to the present invention may be designed as a back monitor camera to be mounted on a vehicle to capture the rear view of the vehicle as a two-dimensional video image, a monitoring camera to be installed in a building or a construction site, or an optical identification device to be set in an ATM in a financial institution for performing personal identification based on a palm vein pattern.

1. A wide-angle lens comprising an object-side lens group, an image-forming side lens group, and one or more converging lens arranged between the object-side lens group and the image-forming side lens group,
wherein the object-side lens group comprises one or more concave lenses each including a convex light incident surface on the object side, and
wherein the light incident surface of the concave lens is a convex aspheric surface whose curvature increases from a central optical axis toward a periphery of the lens, the concave lens further including a light emitting surface which is a substantially concave spherical surface.

2. The wide-angle lens according to claim 1, wherein the image-forming side lens group is designed to form an image of an object on an image-forming surface with reduced image distortion.

3. The wide-angle lens according to claim 2, wherein the object-side lens group consists of a single concave lens, and the wide-angle lens has an angle of view in a range of 60° to 100°.

4. The wide-angle lens according to claim 2, wherein the object-side lens group consists of two concave lenses, and the wide-angle lens has an angle of view in a range of 100° to 130°.

5. The wide-angle lens according to claim 2, wherein the object-side lens group consists of three concave lenses, and the wide-angle lens has an angle of view in a range of 100° to 170°.

6. The wide-angle lens according to claim 4, wherein, of the concave lenses constituting the object-side lens group, the concave lens arranged closest to an object is made of resin, whereas the other concave lens or lenses are made of molded glass whose Abbe number is not smaller than 70.

7. The wide-angle lens according to claim 2, wherein an Abbe number of the converging lens is smaller than an Abbe number of the concave lens constituting the object-side lens group.

8. The wide-angle lens according to claim 7, wherein the concave lens constituting the object-side lens group and the converging lens are made of resin.

9. An optical device comprising: a wide-angle lens as set forth in claim 1; and a two-dimensional area sensor which is so arranged that a light receiving surface thereof is located on the image-forming surface.

10. A camera module comprising: a wide-angle lens as set forth in claim 1; and a two-dimensional area sensor which is so arranged that a light receiving surface thereof is located on the image-forming surface, wherein the camera module is designed to obtain a two-dimensional image of an object by the two-dimensional area sensor.

11. An image reader comprising: a transparent document table; and the camera module as set forth in claim 10, the camera module being arranged below the document table, wherein the image reader is designed to obtain a two-dimensional image of a document placed on the document table by the two-dimensional area sensor.

12. A method for manufacturing a wide-angle lens comprising an object-side lens group, an image-forming side lens group, and one or more converging lens arranged between the object-side lens group and the image-forming side lens group, the object-side lens group comprising one or more concave lenses each including a convex light incident surface on the object side, the light incident surface of the concave lens comprising a convex aspheric surface, the concave lens further including a light emitting surface which is a substantially concave spherical surface;
the method comprising the steps of:
preparing the image-forming side lens group to be capable of forming an image of an object on an image-forming surface by itself with reduced image distortion; and
determining specifications of the lens for constituting the object-side lens group and the converging lens so that an image with reduced image distortion is to be formed on the image-forming surface.

13. A method for manufacturing a wide-angle lens comprising an object-side lens group, an image-forming side lens group, and one or more converging lenses arranged between the object-side lens group and the image-forming side lens group, the object-side lens group comprising one or more concave lenses each including a light incident surface which is a convex aspheric surface and a light emitting surface which is a substantially concave spherical surface, the method being capable of producing wide-angle lenses of different angles of view by appropriately selecting the number of the concave lenses for constituting the object-side lens group;
the method comprising:
preparing the image-forming side lens group by using a lens group of predetermined specifications which make it possible to form an image of an object on an image-forming surface with reduced image distortion;
wherein, when the object-side lens group is to consist of a single concave lens, specifications of the single concave lens and the converging lens are so determined that an image with reduced image distortion is to be formed on the image-forming surface; and
wherein, when the object-side lens group is to consist of two or more concave lenses, the specifications of the single concave lens for the structure in which the object-side lens group consists of a single concave lens is used as it is, and one or more additional concave lenses are arranged on the object side of said concave lens, and specifications of the additional concave lens or lenses and the converging lens are so determined that an image with reduced image distortion is to be formed on the image-forming surface.
